(19) United States
(12) Patent Application Publication
(10) Pub. No.: US 2017/0180125 A1
(43) Pub. Date: Jun. 22, 2017

(54) DEVICE AND METHOD FOR THE PERSONALIZED PROVISION OF A KEY

(71) Applicant: DEUTSCHE POST AG, BONN (DE)

(72) Inventor: MIKE BOBINSKI, BONN (DE)

(21) Appl. No.: 15/377,468

(22) Filed: Dec. 13, 2016

(30) Foreign Application Priority Data
Dec. 17, 2015 (DE) 102015225778.9

(51) Int. Cl. H04L 9/08; G07C 9/00; H04L 9/30; H04L 9/32; H04L 9/14

(52) U.S. Cl. CPC H04L 9/0877; H04L 9/3231; H04L 9/14; H04L 9/30; H04L 9/3263; G07C 9/00087; G07C 9/00857; G07C 2009/00095; G07C 2009/00769

(57) ABSTRACT

A device and a method is disclosed for the personalized provision of a key for processing target information. The device comprises an information receiving means to receive biometric information about the user, a storage device for storing biometric reference information, an authentication means to compare the user's biometric information, which was received by the biometric information acquisition means, to the stored biometric reference information, and an output means to output information. The device also comprises a cryptographic unit, whereby the cryptographic unit can use the biometric information about the user to generate the key, whereby the key can be output via the output means. The method comprises receiving biometric information about the user, comparing the received biometric information about the user to previously stored biometric reference information, and generating the key for processing target information on the basis of the biometric information about the user.

The invention relates to a device and to a method as well as to a system for the personalized provision of a key for processing target information, whereby access to the key is secured by biometric methods.

The target information, in turn, can be a key for secure access. This access can be in the form of a door, for example, the door to a compartment such as a parcel compartment system, a bank safe-deposit box or a room or an access-restricted area. An access-restricted area can be an event hall or area, a stadium or else a security area. By the same token, access can also be understood as access to a piece of information, whereby the information can be decrypted with a key if the information is present in encrypted form, or if the information can be encrypted, for example, in order to forward it securely. Moreover, access can also refer to approval of a transaction, for example, a bank transfer within the scope of electronic banking or, for instance, electronic access to a document, for example, an entry permit.

Various methods and devices for the provision of keys are known from the state of the art. For example, transaction numbers (TAN) can be generated by a provider and transmitted to the user, for instance, via an information service such as Short Message Service (SMS). By the same token, personal identification numbers (PIN) or passwords can be provided to a user. These, in turn, can be generated for repeated use or for one-time use. Moreover, ID cards such as, for example, access badges with various applied or integrated security features, are known.

When keys are transmitted, errors and, as a result, unauthorized use of a key can occur. Misuse due to targeted unauthorized data theft during transmission has also occurred.

In general, there is a need for an increase in security.

For quite some time now, the use of biometric information about a user in order to authenticate him/her has become common practice. In this context, biometric data, for example, data obtained from a fingerprint or an eye scan (the fundus or the iris of the eye) is used. A biometric recognition system essentially makes use of the following steps: acquiring the measured values, extracting the features and comparing the features. Sensors are used to acquire the measured values, whereby the type of sensor depends largely on the biometric characteristics. Thus, for example, a video camera is suitable for most characteristics; other imaging methods are also options when it comes to fingerprint recognition. The sensor component yields a biometric sample as its result. The feature extraction yields complex algorithms of biometric samples as its result. Finally, when the features are compared, a comparative value between the biometric reference value stored during a learning phase and the current data record obtained from the feature extraction is calculated. If this comparative value exceeds or falls below a (selectable) threshold, then the recognition is said to have been successful.

Depending on the threshold value, the use of biometric information about a user is suitable for increasing access security. However, in actual practice, the method turns out to be laborious: complicated sensors are needed to acquire the biometric features and they have to be installed at every possible access point. In actual practice, these sensors are connected to a central computer in which the reference data is stored and on which the feature comparison is carried out. The result of the feature comparison is transmitted to the access point and the appropriate action, that is to say, permitting or denying access, is carried out on site.

Before this backdrop, the objective of the invention is thus to put forward a device and a corresponding method for the personalized provision of a key for processing target information which increases the security of the key provision and, at the same time, minimizes the requisite effort as compared to prior-art methods, in addition to which increased security is attained. Moreover, it is the objective of the invention to put forward a system for the personalized provision of a key for processing target information.

According to the invention, this objective is achieved by a device having the features of the independent claim 1. Advantageous refinements of the device ensue from the subordinate claims 2 to 6. The objective is also achieved by a method according to claim 7. Advantageous embodiments of the method ensue from the subordinate claims 8 to 14. The additional objective of the invention is achieved by the system according to claim 15.

A device according to the invention for the personalized provision of a key for processing target information, whereby the device can be worn by a user, comprises an information receiving means to receive biometric information about the user, a storage device for storing biometric reference information, an authentication means to compare the user's biometric information, which was received by the biometric information acquisition means, to the stored biometric reference information, and an output means to output information. In particular, the device according to the invention also comprises a cryptographic unit, whereby, for instance, the cryptographic unit can use the biometric information about the user to generate the key or to activate access to a previously generated and stored key, whereby the key can be output via the output means.

The method according to the invention for the personalized provision of a key for processing target information by means of a device that can be worn by a user comprises the following steps: receiving biometric information about the user, comparing the received biometric information about the user to previously stored biometric reference information, as well as generating the key or activating the access to a previously generated and stored key for processing target information on the basis of the biometric information about the user.

The method is thus characterized in that biometric information about the user is used to generate or activate the key for processing the target information. Consequently, the key can only be generated or activated by unique information that only the user has. The key is only generated or activated by the device at the moment when it is needed, and it does not have to be transmitted to the user. If the device is in the possession of the user, it is possible to dispense with the error-prone step of transmitting the key from an external location to the user. The user does not need a receiving means such as, for example, an electronic device with an Internet connection. This increases the security of the method and reduces the effort involved.

In an advantageous embodiment, the method according to the invention also comprises the step of checking whether the device is being worn by the user. The key is only generated if the device is being worn by the user. For this purpose, the device according to the invention has a sensor by means of which it can be checked whether the device is being worn by the user.

For example, in order to generate the key, the biometric feature can be acquired at the moment when the key is going to be generated. Via the sensor in the device, the biometric feature is acquired and compared to the reference feature that is stored in the device. If there is a correspondence between the acquired feature and the reference feature within previously definable limits, then the cryptographic unit of the device is activated and/or the key containing the input information of the acquired biometric feature or, as an alternative, of the reference feature, is generated.

In another advantageous embodiment, the biometric information that is used as the biometric information about the user can only be obtained from a living organism. Such biometric information comprises, for example, the pulse or the pattern in the fundus or in the iris of the eye. In contrast, for example, a fingerprint can also be obtained from a deceased person. The pulse of a human is unique with sufficient reliability, that is to say, the pulse is different for almost all persons. Moreover, a characteristic value can be derived from the pulse, which is independent of a person's age or of the point in time of the measurement. Moreover, a person's pulse can be measured very simply and very reproducibly. The same applies to the pattern in the fundus or in the iris of the eye.

Moreover, it has proven to be advantageous for the device to be integrated into a piece of equipment that can be worn by the user. The term “wearables”—for wearable computing—has been coined for such pieces of equipment. Depending on the biometric information, different wearables are conceivable and advantageous. For example, the wearable can be a band such as a chest strap or a wristband. Such bands are easy to put on and offer good contact between the device arranged in the bands, especially an information receiving means arranged in the device, and the user, so that the biometric feature can be reliably acquired. The wearable can, however, also be, for example, eye glasses such as so-called smart glasses into which the device is integrated.

It has also proven to be advantageous for the key to be output, especially preferably, wirelessly. For this purpose, the device according to the invention preferably has an output means that is suitable for transmitting information wirelessly. The wireless output can be transmitted, for example, via Near Field Communication (NFC), that is to say, using radio technology such as, for instance, WLAN or RFID and Bluetooth, or else optically, for example, via infrared interfaces.

In an advantageous embodiment, the cryptographic unit has a cryptochip. The cryptographic computing operations are thus carried out in a dedicated secure processor, which further increases the security. This processor consists of a complete single-chip computer (microprocessor, RAM, ROM, EEPROM, operating system) with complicated hard-wired and programmable security functions. Security-relevant data cannot be read out directly since it is only available to the processor.

It is also possible to use the generated key to decrypt encrypted information that had been previously stored in the device. In this context, the encrypted information that is stored in the device can enter the memory of the device via an input means such as, for example, a receiver for NFC or an optical interface. The decrypted information can be shown, for example, on a display of the device. However, the decrypted information can also be output from the device, for example, likewise via NFC or via an optical interface.

Conversely, it is also possible to use the generated key to encrypt information that had been previously stored in the device. In this context, the encrypted information that is stored in the device can enter the memory of the device via an input means as mentioned above. This encrypted information can then be output from the device, for example, likewise via NFC or via an optical interface.

Moreover, it is possible to use the generated key to sign information that had been previously stored in the device.

For all inputs and/or outputs, of course, it is also conceivable to use a hard-wired interface such as, for example, a USB interface.

In an advantageous embodiment, an initialization of the device that can be worn by the user precedes the method for the personalized provision of a key for processing target information. The initialization comprises the following steps:
ascertaining and storing the identity of the user,
assigning an unambiguous user-ID,
receiving biometric information about the user,
initializing an electronic device for generating the key for the user-ID and generating a pair of master keys consisting of a public and a private key,
generating a digital data record in order to confirm the identity of the user, making use of the public key,
storing the digital data record in the electronic device.

When the user starts the initialization of his/her device, the process of ascertaining the identity of the user is started, for example, in an identification service. The identity can be ascertained, for example, in that an official photo-ID of the user is presented, which can be done personally, for instance, by means of the PostIdent procedure of Deutsche Post AG. However, it can also be carried out, for example, by means of the VideoIdent procedure, which dispenses with the need for the user to appear in person, for example, at a branch of Deutsche Post AG. The identity of the user is stored by the identification service and an anonymous unambiguous user-ID is assigned. This user-ID is transmitted to the device that the user has to put on at the latest now. The device acquires the envisaged biometric information about the user as biometric reference information. Subsequently, the cryptographic unit of the device is initialized for the user-ID and a pair of master keys consisting of a public and a private key is generated. The device sends the public key to the identification service, where it is used to generate one or more digital data records containing the identity of the user in the form of his/her user-ID or other identity attributes such as, for example, first and last names. A possible modality for the digital data record can be implemented in the form of an X.509 certificate. Furthermore, an advantageous version is when the device itself has an unambiguous identifier that it sends to the identification service at the time of the transmission so that it is stored in the identification service together with the digital data records pertaining to the user data. Moreover, the digital data record or the digital data records are sent to the device, where they are stored in the cryptographic unit. As a result, the device and the identity of the user are reciprocally referenced and coupled to each other.

Another advantage arising from this constellation is, for example, the impersonal delivery of an object that is only allowed to be delivered, for instance, to adult persons. If the object is, for example, a parcel, in the state of the art, it may only be delivered in person, and the recipient has to identify himself/herself to the deliverer by presenting an official photo-ID, especially in order to prove that he/she is an adult. Based on the known identity of the user, who, after all, has to present an official photo-ID at the time of the initialization of the device, it is now known whether this user is, for instance, an adult. Consequently, such shipments can be delivered, for example, to a parcel compartment system such as the Packstation of Deutsche Post if the user of the Packstation can only open it with the device according to the invention. Thus, the deliverer can be certain that only the correct user removes the parcel from the Packstation.

The device can be configured, for example, in such a way that the initialization can only be carried out one time. This can be achieved, for example, in that the storage device for storing the biometric reference information is configured as a WORM (write once read many) data storage device.

If a user wishes, for example, to gain access to an access point, he/she indicates this to the access point. The access point then requests the user to authenticate himself/herself. At the latest now, the user puts on the device, which obtains the biometric information from the user and compares it to the biometric reference information stored in the device. If the comparison is negative, an error message is displayed and the process is aborted. This can be indicated, for example, on a display or by means of some other signal such as, for example, a light on the device 1. However, aborting the process can also be understood as such an indication. In contrast, if the comparison is positive, the cryptographic unit 5 is activated in the device 1, which transmits a digital data record containing the user ID to the access point. The authentication of the device 1 can subsequently be carried out, for example, by means of the challenge-response method. With this method, which is familiar to the person skilled in the art, the access point sends a random number to the device 1. The cryptographic unit 5 of the device 1 augments this number with its public key, applies a cryptographic encryption to this combination, and sends the result to the access point, which knows the random number as well as the public key and the encryption employed, and then it carries out the same calculation, it compares its result to the result received from the device 1, and it acknowledges a successful authentication if the data is identical. Subsequently, the access point checks, for example, whether the user identifier transmitted by the user such as, for example, the user ID or the key, is contained in a local database, and it activates the access if this is the case. A success message can be displayed to the user. In case of negative comparison results, error messages can be displayed to the user.

Owing to the initialization, the device can identify the user during a later key generation. Thus, for example, it is not only possible to check whether the device has been authenticated, but also whether the device is being used by the authorized user, a process in which the user can be identified. In other words, it can be checked whether the device is linked to the user. The device yields a 1-to1 relationship between the user and the user ID.

The user can be identified by means of the device and by means of the identification service.

In a first variant for the identification, the user indicates to an access point that he/she wishes to gain access to this access point. As described above, the access point requests the user to authenticate himself/herself. At the latest now, the user puts on the device, which obtains the biometric information from the user and compares it to the biometric reference information stored in the device. If the comparison is negative, an error message is displayed and the process is aborted. This can be indicated, for example, on a display or by means of some other signal such as, for example, a light on the device. However, aborting the process can also be understood as such an indication. In contrast, if the comparison is positive, the cryptographic unit is activated in the device, which transmits a digital data record containing the user ID to the access point. The authentication of the device can subsequently be carried out, for example, by means of the challenge-response method. With this method, which is familiar to the person skilled in the art, the access point sends a random number to the device. The cryptographic unit of the device augments this number with its public key, applies a cryptographic encryption to this combination, and sends the result to the access point, which knows the random number as well as the public key and the encryption employed, and then it carries out the same calculation, it compares its result to the result received from the device, and it acknowledges a successful authentication if the data is identical. At this point, the access point sends a query to the identification service about the identity data pertaining to the user ID. The identification service authenticates the access point and retrieves the identity data pertaining to the user—identified on the basis of the user ID—from the memory and sends this data to the access point, where it is processed, for example, the access authorization is stored locally.

In a second variant for the identification, the user indicates to an access point that he/she wishes to gain access to this access point. The access point requests the identification of the user from the identification service. The identification service then requests the user to authenticate himself/herself. At the latest now, the user puts on the device, which obtains the biometric information from the user and compares it to the -biometric reference information stored in the device. If the comparison is negative, an error message is displayed and the process is aborted. This can be indicated, for example, on a display or by means of some other signal such as, for example, a light on the device. However, aborting the process can also be understood as such an indication. In contrast, if the comparison is positive, the cryptographic unit is activated in the device, which transmits a digital data record containing the user ID to the identification service. The identification service now authenticates the device, for example, by means of the challenge-response method described above. If it was possible to successfully carry out the authentication, a request that the identity data of the user be activated can be sent to the user. If he/she activates his/her identity data or if there is no need for a request for the activation, then the identification service retrieves the identity data from its memory and sends it to the access point, where it is processed, for example, the access authorization is stored locally.

This measure increases the security of the key provision and, at the same time, minimizes the requisite effort as compared to prior-art methods. The security is increased even further if the biometric information that is used is selected in such a way that it can only be obtained from a living organism. Such biometric information comprises, for example, the pulse or the pattern in the fundus or in the iris of the eye.

A system according to the invention for the personalized provision of a key for processing target information is characterized in that the system comprises an initialization component, also an access point and a device that can be worn by a user for the personalized provision of a key for processing target information, whereby the initialization component comprises means to ascertain the identity of a user, means to store the identity of the user, means to assign an unambiguous user ID, means to generate a digital data record, and means to store a digital data record, and whereby the access point has means with which the user can indicate an access wish, means to request the authentication of the user, means to receive a digital data record, means to authenticate the user, and means to query identity data pertaining to a user ID.

The security can be even further increased if the components of the device such as the information receiving means, the storage device, the authentication means, the output means and the cryptographic unit are encapsulated in the device in such a way that they are manipulation-proof, that is to say, for example, the acquisition of the data cannot be simulated or the information cannot be modified during the transmission or storage. This can be achieved, for instance, in that the components are physically protected, for example, in that they are embedded into the device.

Additional advantages, special features and practical refinements of the invention can be gleaned from the subordinate claims and from the presentation given below of preferred embodiments making reference to the figures.

The figures show the following:

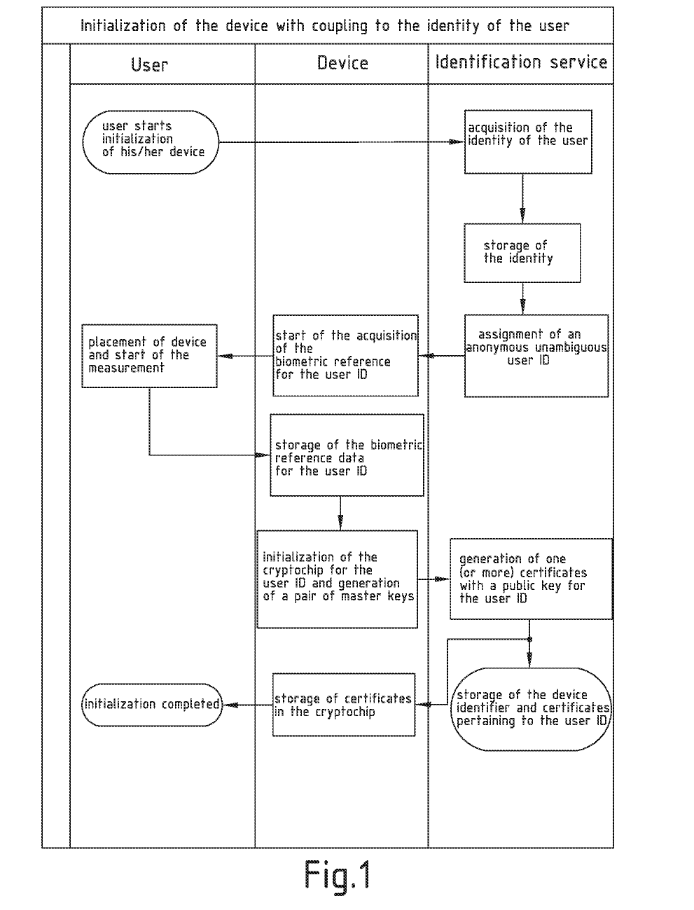

FIG. 1 flow chart for the initialization of the device,

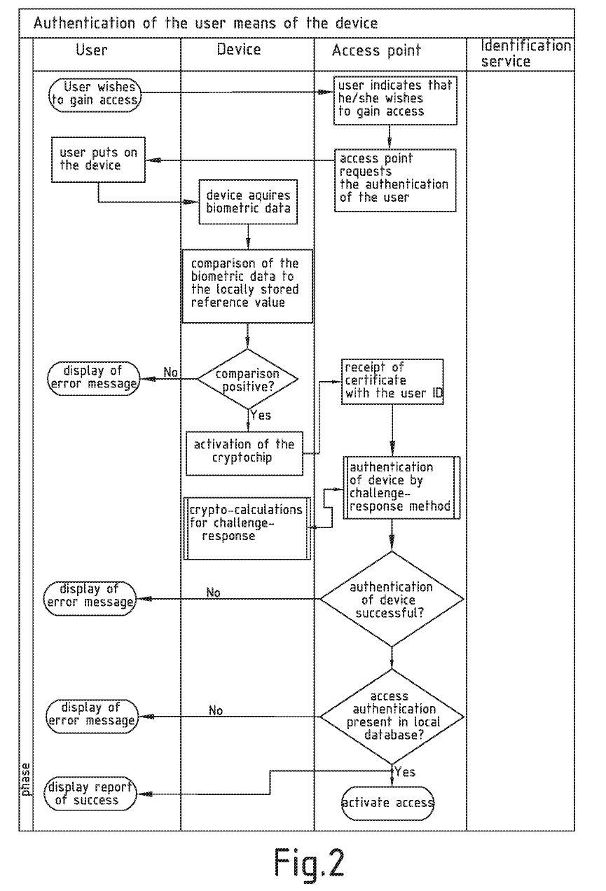

FIG. 2 flow chart for the authentication of the user,

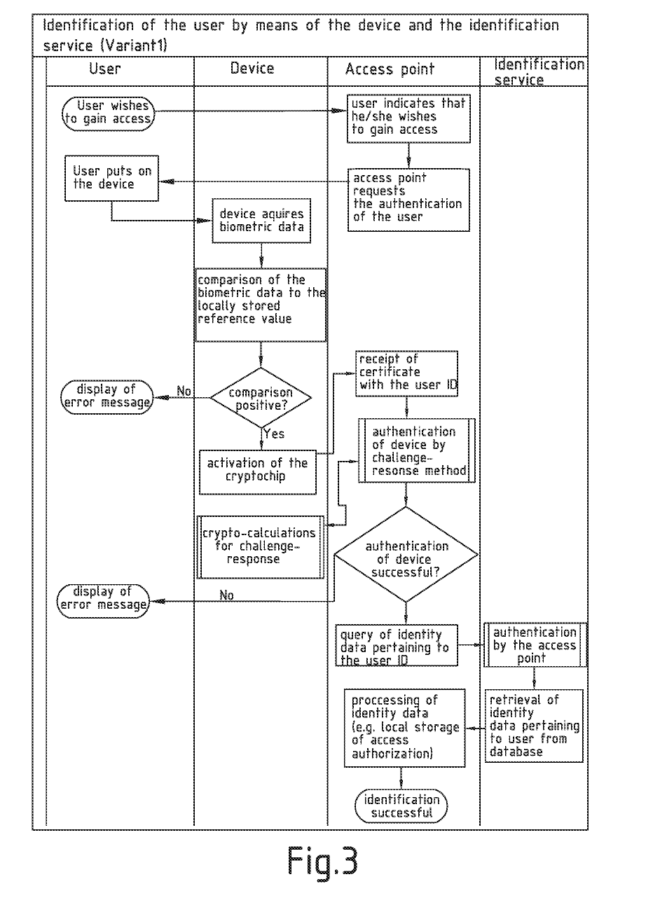

FIG. 3 flow chart for the identification of the user, Variant 1,

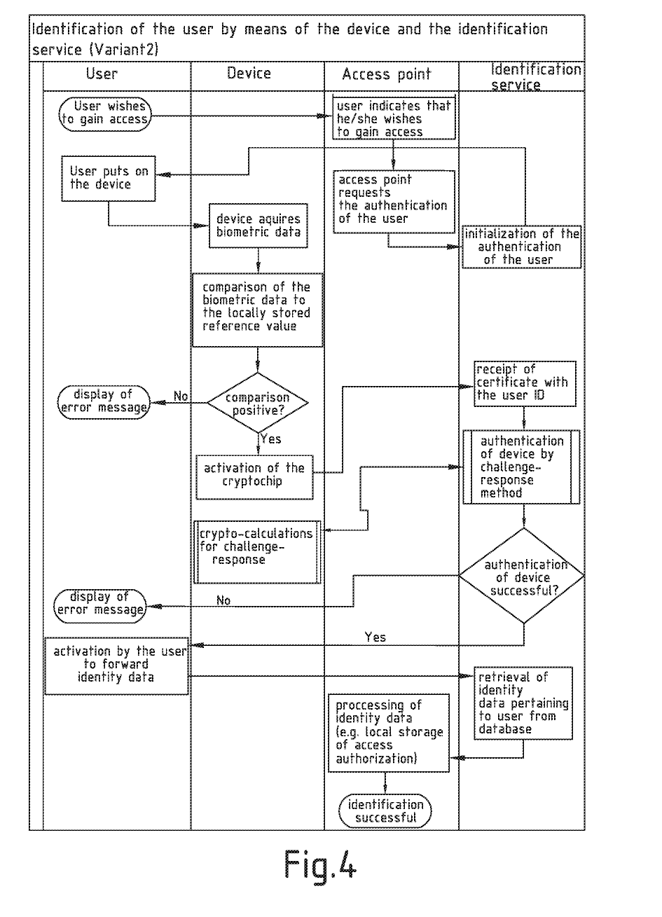

FIG. 4 flow chart for the identification of the user, Variant 2,

FIG. 5 schematic view of a device according to the invention.

FIG. 1 is a flow chart for the initialization of the device 1. When the user starts the initialization of his/her device 1, the process of ascertaining the identity of the user is started, for example, in an identification service. The identity can be ascertained, for example, in that an official photo-ID of the user is presented, which can be done personally, for instance, by means of the PostIdent procedure of Deutsche Post AG. However, it can also be carried out, for example, by means of the VideoIdent procedure, which dispenses with the need for the user to appear in person, for example, at a branch of Deutsche Post AG. The identity of the user is stored by the identification service and an anonymous unambiguous user-ID is assigned. This user-ID is transmitted to the device 1 that the user has to put on at the latest now. The device acquires the envisaged biometric information about the user as biometric reference information. Subsequently, the cryptographic unit 5 of the device 1 is initialized for the user-ID and a pair of master keys consisting of a public and a private key is generated. The device 1 sends the public key to the identification service, where it is used to generate a digital data record in the form of an X.509 certificate containing the identity of the user in the form of his/her user ID. The device 1 itself has an unambiguous identifier that it sends to the identification service at the time of the transmission so that said identifier is stored in the identification service, together with the digital data records pertaining to the user data. Moreover, the digital data record is sent to the device 1, where it is stored in the cryptographic unit 5, thereby completing the initialization. As a result, the device and the identity of the user are reciprocally referenced and coupled to each other.

FIG. 2 is a flow chart for the authentication of the user. If a user wishes, for instance, to gain access to an access point, he/she indicates this to the access point. The access point then requests the user to authenticate himself/herself. At the latest now, the user puts on the device 1 which, by means of an information receiving means 6, obtains the biometric information from the user and compares it to the biometric reference information stored in the device. If the comparison is negative, an error message is displayed and the process is aborted. This can be indicated, for example, on a display or by means of some other signal such as, for example, a light on the device. However, aborting the process can also be understood as such an indication. In contrast, if the comparison is positive, the cryptographic unit 5 is activated in the device 1, which transmits a digital data record containing the user ID to the access point. The authentication of the device 1 can subsequently be carried out, for example, by means of the challenge-response method. With this method, which is familiar to the person skilled in the art, the access point sends a random number to the device 1. The cryptographic unit 5 of the device 1 augments this number with its public key, applies a cryptographic encryption to this combination, and sends the result to the access point, which knows the random number as well as the public key and the encryption employed, and then it carries out the same calculation, it compares its result to the result received from the device 1, and it acknowledges a successful authentication if the data is identical. Subsequently, the access point checks, for example, whether the user identifier transmitted by the user such as, for example, the user ID or the key, is contained in a local database, and it activates the access if this is the case. A success message can be displayed to the user. In case of negative comparison results, error messages can be displayed to the user.

FIG. 3 is a flow chart for a first variant for the identification of the user. The user indicates to an access point that he/she wishes to gain access to this access point. As described above, the access point then requests the user to authenticate himself/herself. At the latest now, the user puts on the device 1, which obtains the biometric information from the user and compares it to the biometric reference information stored in the device 1. If the comparison is negative, an error message is displayed and the process is aborted. This can be indicated, for example, on a display or by means of some other signal such as, for example, a light on the device 1. However, aborting the process can also be understood as such an indication. In contrast, if the comparison is positive, the cryptographic unit 5 is activated in the device, which transmits a digital data record containing the user ID to the access point. The authentication of the device 1 can subsequently be carried out, for example, by means of the challenge-response method. With this method, which is familiar to the person skilled in the art, the access point sends a random number to the device 1. The cryptographic unit 5 of the device 1 augments this number with its public key, applies a cryptographic encryption to this combination, and sends the result to the access point, which knows the random number as well as the public key and the encryption employed, and then it carries out the same calculation, it compares its result to the result received from the device 1, and it acknowledges a successful authentication if the data is identical. At this point, the access point sends a query to the identification service about the identity data pertaining to the user ID. The identification service authenticates the access point and retrieves the identity data pertaining to the user—identified on the basis of the user ID—from the memory and sends this data to the access point, where it is processed, for example, the access authorization is stored locally.

FIG. 4 is a flow chart for the second variant for the identification of the user. The user indicates to an access point that he/she wishes to gain access to this access point. The access point requests the identification of the user from the identification service. The identification service then requests the user to authenticate himself/herself. At the latest now, the user puts on the device 1, which obtains the biometric information from the user and compares it to the biometric reference information stored in the device 1. If the comparison is negative, an error message is displayed and the process is aborted. This can be indicated, for example, on a display or by means of some other signal such as, for example, a light on the device 1. However, aborting the process can also be understood as such an indication. In contrast, if the comparison is positive, the cryptographic unit 5 is activated in the device 1, which transmits a digital data record containing the user ID to the identification service which transmits a digital data record with the user ID to the identification service. The identification service now authenticates the device 1, for example, by means of the challenge-response method described above. If it was possible to successfully carry out the authentication, a request that the identity data of the user be activated can be sent to the user. If he/she activates his/her identity data or if there is no need for a request for the activation, then the identification service retrieves the identity data from its memory and sends it to the access point, where it is processed, for example, the access authorization is stored locally.

FIG. 5 is a flow chart of a device 1 according to the invention. The device 1 is a wristband 7 that comprises an information receiving means 6 in the form of a pulse sensor. Moreover, the wristband 7 has a storage device 2 for storing biometric reference information, an authentication means 3 to compare the user's biometric information, an output means 4 to output the information, and a cryptographic unit 5. The cryptographic unit 5 is configured to generate the key containing the biometric information about the user. All of the components are embedded in the wristband with a casting compound so that they cannot be removed from the wristband without being destroyed or so that they cannot be manipulated while in the wristband.

The embodiments shown here constitute merely examples of the present invention and therefore must not be construed in a limiting fashion. Alternative embodiments considered by the person skilled in the art are likewise encompassed by the scope of protection of the present invention.

### LIST OF REFERENCE NUMERALS

1 device
2 storage device for storing biometric reference information
3 authentication means to compare the biometric information about the user
4 output means
5 cryptographic unit
6 information receiving means
7 piece of equipment

1. A device for the personalized provision of a key for processing target information, whereby the device can be worn by a user, comprising
an information receiving means for receiving biometric information about the user;
a storage device for storing biometric reference information;
an authentication means to compare the user's biometric information, which was received by the biometric information acquisition means, to the stored biometric reference information;
an output means to output information;
characterized in that
the device also comprises a cryptographic unit, whereby the cryptographic unit can use the biometric information about the user to generate the key or to activate access to a previously generated and stored key, whereby the key can be output via the output means.

2. The device according to claim 1,
characterized in that
the device also has a sensor by means of which it can be checked whether the device is being worn by the user.

3. The device according to claim 1,
characterized in that
the biometric information about the user can only be obtained from a living organism.

4. The device according to claim 1,
characterized in that
the device is integrated into a piece of equipment that can be worn by the user.

5. The device according to claim 1,
characterized in that
the output means is suitable for transmitting information wirelessly.

6. The device according to claim 1,
characterized in that
the cryptographic unit has a cryptochip.

7. A method for the personalized provision of a key for processing target information by means of a device that can be worn by the user, comprising the following steps:
receiving biometric information about the user;
comparing the received biometric information about the user to previously stored biometric reference information;
characterized in that
the method also comprises the step that, on the basis of the biometric information about the user, the key for processing the target information is generated or the access to a previously generated and stored key is activated.

8. The method according to claim 7,
characterized in that
the method also comprises the step of checking whether the device is being worn by the user, whereby the key is only generated if the device is being worn by the user.

9. The method according to claim 7,
characterized in that
there is a preceding initialization of the device that can be worn by the user,
whereby the initialization comprises the following steps:
ascertaining and storing the identity of the user,
assigning an unambiguous user-ID,
receiving biometric information about the user,
initializing an electronic device for generating the key for the user-ID and generating a pair of master keys consisting of a public and a private key,
generating a digital data record in order to confirm the identity of the user, making use of the public key,
storing the digital data record in the device.

10. The method according to claim 7,
characterized in that
the biometric information about the user is information that can only be obtained from a living organism.

11. The method according to claim 7,
characterized in that
the key is output.

12. The method according to claim 7,
characterized in that
the generated key is used to decrypt encrypted information that had been previously stored in the device.

13. The method according to claim 7,
characterized in that
the generated key is used to encrypt information that had been previously stored in the device.

14. The method according to claim 7,
characterized in that
the generated key is used to sign information that had been previously stored in the device.

15. A system for the personalized provision of a key for processing target information,
characterized in that
the system comprises an initialization component, an access point and a device according to claim 1, whereby the initialization component comprises means to ascertain the identity of a user, means to store the identity of the user, means to assign an unambiguous user ID, means to generate a digital data record, and means to store a digital data record, and whereby the access point has means with which the user can indicate an access wish, means to request the authentication of the user, means to receive a digital data record, means to authenticate the user, and means to query identity data pertaining to a user ID.
